(19) United States
(12) Patent Application Publication
(10) Pub. No.: US 2019/0139333 A1
(43) Pub. Date: May 9, 2019

(54) METHOD, APPARATUS AND COMPUTER PROGRAM FOR DETERMINING RECORDING TIME OF EVENT DATA RECORDER USING ACOUSTIC ANALYSIS

(71) Applicant: Republic of Korea (Ntl Forensic Service Director Ministry of Public Administration and Security), Seoul (KR)

(72) Inventors: Jae Hyeong Lee, Chilgok-gun (KR); Young Nae Lee, Nam-gu (KR); Nam Kyu Park, Bucheon-si (KR); Jong Chan Park, Gimpo-si (KR); Jong Jin Park, Wonju-si (KR)

(21) Appl. No.: 16/110,961

(22) Filed: Aug. 23, 2018

(30) Foreign Application Priority Data
Nov. 6, 2017 (KR) 10-2017-0146789

(51) Int. Cl. G07C 5/08; G06F 17/14

(52) U.S. Cl. CPC G07C 5/085; G06F 17/142; G06F 17/14

(57) ABSTRACT

Provided is a method of determining a recording time of an event data recorder (EDR) includes obtaining, from the EDR of a vehicle, main engine revolutions per minute (RPM) record data of which the recording time is unknown; obtaining, from an acoustic storage apparatus, time domain acoustic data including acoustic information of an event time of the vehicle; calculating frequency domain acoustic data from the time domain acoustic data by using Fourier transformation; calculating RPM estimation data of the vehicle of the event time from the frequency domain acoustic data by using order analysis; and determining whether a time when the EDR records the RPM record data is identical to the event time by comparing the RPM estimation data of the vehicle with the RPM record data.

### CROSS-REFERENCE TO RELATED APPLICATION

This application claims the benefit of Korean Patent Application No. 10-2017-0146789, filed on Nov. 6, 2017, in the Korean Intellectual Property Office, the disclosure of which is incorporated herein in its entirety by reference.

### BACKGROUND

### 1. Field

One or more embodiments relate to a method, apparatus and computer program for determining a recording time of an event data recorder (EDR) using acoustic analysis.

### 2. Description of the Related Art

Vehicles are widely used for transport in modern life, and distribution of vehicles has spread to an extent that almost every household has a vehicle. There may be various events that a vehicle may experience, and it is important to find out an exact cause of an event because problems frequently occur when parties of an event make different claims about the cause of the event. In particular, an instantaneous velocity and main engine revolutions per minute (RPM) at the moment of a car event are important factors in analyzing the cause of the event.

Recently, in order to objectively analyze the cause of an event, an event data recorder (EDR) is increasingly commonly mounted on a vehicle.

### SUMMARY

One or more embodiments include an apparatus and method for determining a recording time of an event data recorder (EDR) capable of determining whether an event record stored in the EDR is due to an event to be analyzed through acoustic analysis.

Additional aspects will be set forth in part in the description which follows and, in part, will be apparent from the description, or may be learned by practice of the presented embodiments.

According to one or more embodiments, a method of determining a recording time of an event data recorder (EDR) includes obtaining, from the EDR of a vehicle, main engine revolutions per minute (RPM) record data of which the recording time is unknown; obtaining, from an acoustic storage apparatus, time domain acoustic data including acoustic information of an event time of the vehicle; calculating frequency domain acoustic data from the time domain acoustic data by using Fourier transformation; calculating RPM estimation data of the vehicle of the event time from the frequency domain acoustic data by using order analysis; and determining whether a time when the EDR records the RPM record data is identical to the event time by comparing the RPM estimation data of the vehicle with the RPM record data.

The determining may include: in a case where a difference between a value of the RPM record data at a reference time and the a value of the RPM estimation data at the event time is within a predetermined error range, determining that the time when the EDR records the RPM record data is identical to the event time.

The RPM record data may include first event record data and second event record data, and the determining may include: determining whether a time when the EDR records the first event record data and the second event record data is identical to the event time by comparing the RPM estimation data with each of the first event record data and the second event record data.

According to one or more embodiments, an apparatus for determining a recording time of an event data recorder (EDR) includes: an EDR data obtaining unit configured to obtain, from the EDR of a vehicle, main engine revolutions per minute (RPM) record data of which the recording time is unknown; time domain acoustic data obtaining unit configured to obtain, from an acoustic storage apparatus, time domain acoustic data including acoustic information of an event time of the vehicle; an acoustic analysis unit configured to calculate frequency domain acoustic data from the time domain acoustic data by using Fourier transformation and calculate RPM estimation data of the vehicle of the event time from the frequency domain acoustic data by using order analysis; and an EDR recording time determination unit configured to determine whether a time when the EDR records the RPM record data is identical to the event time by comparing the RPM estimation data of the vehicle with the RPM record data.

In a case where a difference between a value of the RPM record data at a reference time and the a value of the RPM estimation data at the event time is within a predetermined error range, the EDR recording time determination unit is further configured to determine that the time when the EDR records the RPM record data is identical to the event time.

The RPM record data may include first event record data and second event record data, and the EDR recording time determination unit may be further configured to determine whether a time when the EDR records the first event record data and the second event record data is identical to the event time by comparing the RPM estimation data with each of the first event record data and the second event record data.

According to one or more embodiments, a non-transitory computer-readable recording medium having recorded thereon a program for performing the method in a computer is provided.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view schematically showing an event data recorder (EDR) for storing an event record of a vehicle in which an event has occurred;

FIG. 2 is a view showing uncertainty of an EDR recording time determination when a plurality of events occur in a vehicle;

FIG. 3 is a conceptual diagram schematically showing relationships between an EDR recording time determination apparatus, an EDR, and an acoustic storage apparatus, according to an embodiment;

FIG. 4 is a block diagram of an EDR recording time determination apparatus according to an embodiment;

FIG. 5 is a flowchart illustrating an EDR recording time determination method according to an embodiment;

FIGS. 6A-6C are views schematically illustrating a principle of calculating frequency domain acoustic data using Fourier transformation, from time domain acoustic data;

FIG. 7 is an analysis example of a spectrogram obtained by performing short-time Fourier transformation (STFT) on time domain acoustic data obtained from a black box;

FIGS. 8A-8B are partial views of a black box image of a vehicle with respect to which two events occurred;

FIGS. 9A-9B are spectrogram and a time domain acoustic data graph before and after the events of FIGS. 8A-8B, calculated from black box acoustic information;

FIG. 10 is a graph comparing main engine revolutions per minute (RPM) record data and RPM measurement data of the events of FIG. 8;

FIG. 11 is a graph for explaining a case in which one of a plurality of event record data corresponds to EDR measurement data; and

FIG. 12 is a graph for explaining a case in which all of a plurality of event record data are not identical to EDR measurement data.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

As the present disclosure allows for various changes and numerous embodiments, particular embodiments will be illustrated in the drawings and described in detail in the written description. The attached drawings for illustrating one or more embodiments are referred to in order to gain a sufficient understanding, the merits thereof, and the objectives accomplished by the implementation. However, the embodiments may have different forms and should not be construed as being limited to the descriptions set forth herein.

While such terms as “first,” “second,” etc., may be used to describe various components, such components must not be limited to the above terms. The above terms are used only to distinguish one component from another.

An expression used in the singular encompasses the expression of the plural, unless it has a clearly different meaning in the context.

In the present specification, it is to be understood that the terms such as “including,” “having,” and “comprising” are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

When a certain embodiment may be implemented differently, a specific process order may be performed differently from the described order. For example, two consecutively described processes may be performed substantially at the same time or performed in an order opposite to the described order.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The word mechanism is used broadly and is not limited to mechanical or physical embodiments, but may include software routines in conjunction with processors, etc.

As used herein, “time domain acoustic data” includes a data set that represents amplitude of a sound wave over time.

As used herein, “frequency domain acoustic data” includes a frequency-gain data set obtained by performing Fourier transformation on the time domain acoustic data.

As used herein, an “event” means a state in which an object, a pedestrian or the like comes in contact with a vehicle 1 and an impact force greater than a predetermined level is applied to the vehicle 1.

Sizes of components in the drawings may be exaggerated for convenience of explanation. In other words, since sizes and thicknesses of components in the drawings are arbitrarily illustrated for convenience of explanation, the following embodiments are not limited thereto.

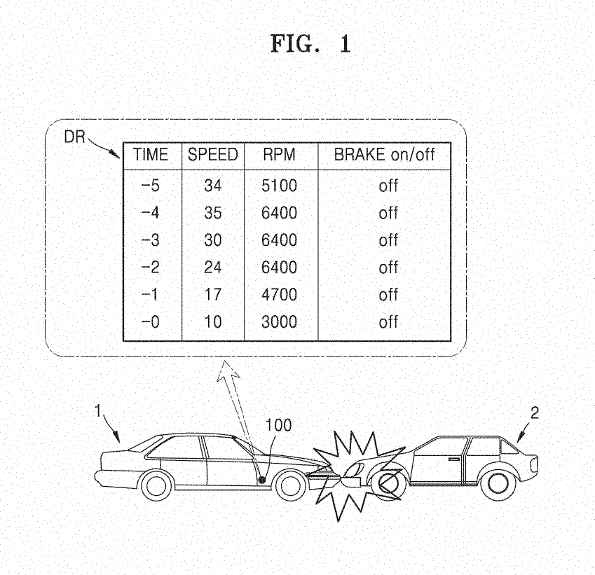

FIG. 1 is a view schematically showing an event data recorder (EDR) 100 for storing an event record of the vehicle 1 in which an event has occurred.

The EDR 100 is a data recording apparatus built in an airbag control unit (ACU) or an engine electronic control unit (ECU) of the vehicle 1, and, when the vehicle 1 collides with another object 2 and an impact force greater than a certain level is applied, is an apparatus for recording traveling information such as speed of the vehicle 1 before about 5 seconds from a reference point (0 second) that is an impact occurrence time, a main engine revolutions per minute (hereinafter also referred to as “RPM”), whether a brake operates, an accelerator pedal position, etc. When an event such as a sudden acceleration or a collision occurs, an operation for analyzing a cause of the event and whether there is an error is performed through data stored in the EDR 100 (hereinafter, referred to as “EDR record data”).

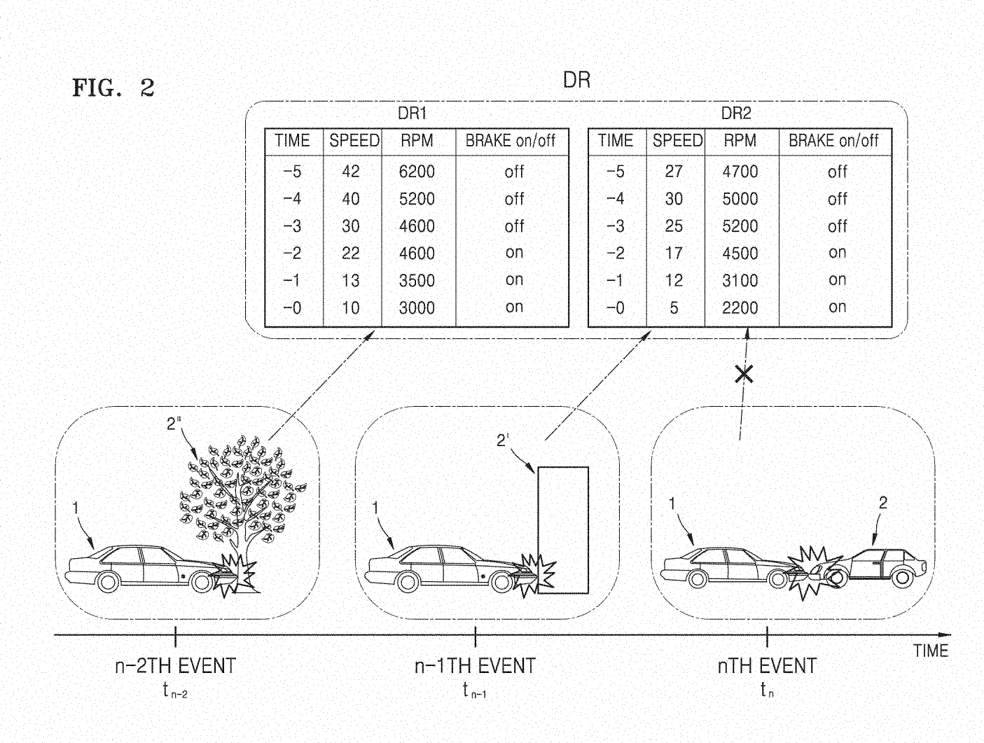

FIG. 2 is a view showing uncertainty of an EDR recording time determination when a plurality of events occur in the vehicle 1. The EDR 100 stores an event record DR but does not record an event occurrence time. That is, time data included in the EDR 100 includes only information about a few seconds relatively before a reference time which is an impact occurrence time, but does not include objective time information. On the other hand, in general, the EDR 100 stores a maximum of two event records, but also does not record the order of the event record.

Accordingly, it is not possible to confirm that the event record DR recorded in the EDR 100 is caused by an event to analyze a cause. That is, referring to FIG. 2, although the vehicle 1 hits other objects 3′ and 3″, there is a possibility that event records DR1 and DR2 are respectively recorded at times tₙ₋₁ and tₙ₋₂ when an ‘n-2th event’ and an ‘n-1th event’ have occurred. Therefore, in order to analyze the cause of an event based on the event record DR recorded in the EDR 100, it is necessary to precede an operation of determining whether the event record DR is recorded at a time tₙ when an ‘n-th event’ has occurred.

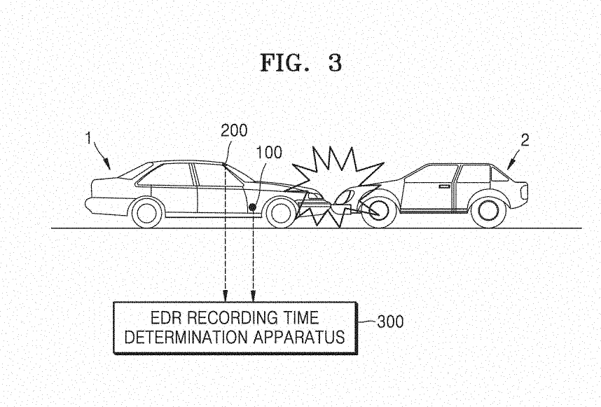

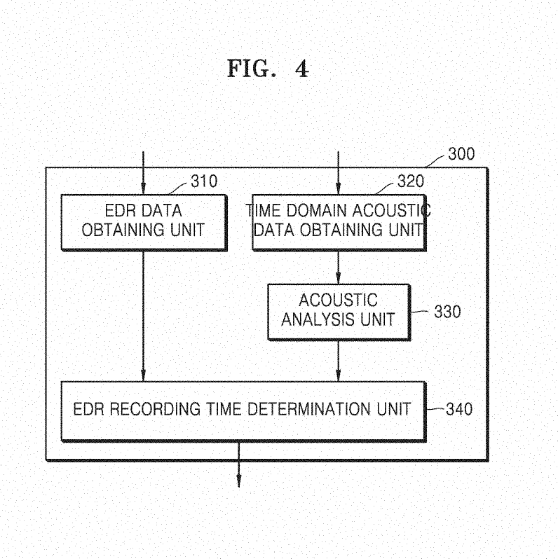

FIG. 3 is a conceptual diagram schematically showing relationships between an EDR recording time determination apparatus 300, the EDR 100, and an acoustic storage apparatus 200, according to an embodiment. FIG. 4 is a block diagram of the EDR recording time determination apparatus 300 according to an embodiment.

The EDR recording time determination apparatus 300 shown in FIG. 4 shows only components related to the present embodiment in order to prevent the feature of the present embodiment from being blurred. Accordingly, it will be understood by those of ordinary skill in the art that other general-purpose components other than the components shown in FIG. 4 may be further included.

The EDR recording time determination apparatus 300 according to the present embodiment may correspond to at least one processor or may include at least one processor. Accordingly, the EDR recording time determination apparatus 300 may be driven by being included in another hardware apparatus such as a microprocessor or a general purpose computer system.

Referring to FIG. 3, the EDR 100 is mounted inside the vehicle 1. The EDR 100 stores an event record prior to an event time when an event occurs such as the vehicle 1 is in contact with another vehicle 2 or the like as described above. At this time, the event record is stored in a state in which a record time is unknown.

The EDR 100 may record and store particularly a main engine revolutions per minute (hereinafter, also referred to as “RPM”) of the vehicle 1. Hereinafter, RPM data stored in the EDR 100 will be referred to as “RPM record data” or “RPM record data”.

The acoustic storage apparatus 200 stores time domain acoustic data including sound information generated inside/outside the vehicle 1. At this time, the acoustic storage apparatus 200 may store acoustic information before and after the event time of the vehicle 1 that requires an event cause analysis. The acoustic storage apparatus 200 may be mounted on the vehicle 1. For example, the acoustic storage apparatus 200 may be a black box. Alternatively, the acoustic storage apparatus 200 may be a separate device installed on the road around the vehicle 1 at the event time. Alternatively, the acoustic storage apparatus 200 may be a black box mounted on the other vehicle 2 that passed around the vehicle 1 at the event time.

The EDR recording time determination apparatus 300 obtains the time domain acoustic data including acoustic information at the event time of the vehicle 1 from the acoustic storage apparatus 200 and then analyzes the time domain acoustic data to estimate RPM of the vehicle 1 at the event time. Hereinafter, the RPM calculated by the EDR recording time determination apparatus 300 will be referred to as “RPM estimation data”. The EDR recording time determination apparatus 300 compares the RPM estimation data obtained through an acoustic analysis with the RPM record data obtained from the EDR 100 to determine whether the data recording time of the EDR 100 is identical to the event time.

Referring to FIG. 4, the EDR recording time determination apparatus 300 according to an embodiment may include an EDR data obtaining unit 310, a time domain acoustic data obtaining unit 320, an acoustic analysis unit 330, and an EDR recording time determination unit 340.

The EDR data obtaining unit 310 obtains the RPM record data of which recording time is unknown from the EDR 100. The EDR data obtaining unit 310 may obtain event records at various times included in the RPM record data. That is, according to an embodiment, the RPM record data may include first event record data and second event record data recorded by different events.

The time domain acoustic data obtaining unit 320 (hereinafter, also referred to as the acoustic data obtaining unit 320) obtains time domain acoustic data including acoustic information at the event time of the vehicle 1 from the acoustic storage apparatus 200. At this time, data before and after the ‘event time’ may be selected from among the time domain acoustic data obtained from the acoustic storage apparatus 200 and utilized for analysis. For example, since a louder sound is generated than usual due to an impact sound at an event, the time domain acoustic data obtaining unit 320 may determine a moment when sound with a strength (dB) higher than a predetermined threshold value is generated as the ‘event time’. The threshold value may be set in consideration of the intensity of the impact sound that is normally generated in the event of the vehicle 1. Unlike this, a user of the EDR recording time determination apparatus 300 may directly select the time domain acoustic data before and after the ‘event time’. For example, the user may recognize when a large impact sound of “banging” occurs, as the “event time”, and then the user may select only data of a predetermined time before and after occurrence of the impact sound and utilize the data for acoustic analysis.

In a case where the acoustic storage apparatus 200 is the black box, the acoustic storage apparatus 200 may include not only an acoustic sensor unit that senses sound during traveling of the vehicle 1 and stores acoustic information but also an image capturing unit that captures and stores an image at a certain time interval during the traveling of the vehicle 1. At this time, the acoustic data obtaining unit 320 may obtain image data synchronized with the time domain acoustic data from the black box. The image data may include, for example, an image at the event time of the vehicle 1. Accordingly, the acoustic data obtaining unit 320 may receive the time domain acoustic data synchronized with a specific image time. Here, a specific image may include an image at the event time of the vehicle 1 among images stored in the image capturing unit, At this time, the user may reproduce the image data and recognize a moment when the vehicle 1 hits another object in the image as the ‘event time’. Then, the user may select time domain acoustic data of a certain period of time before and after the ‘specific image’ and used the time domain acoustic data for acoustic analysis.

The acoustic analysis unit 330 receives the time domain acoustic data before and after the event time from the acoustic data obtaining unit 210, and calculates frequency domain acoustic data using a Fourier transform. At this time, the acoustic analysis unit 330 may calculate the frequency domain acoustic data including information of a frequency domain f-domain, for example, using Fast Fourier Transformation (FFT).

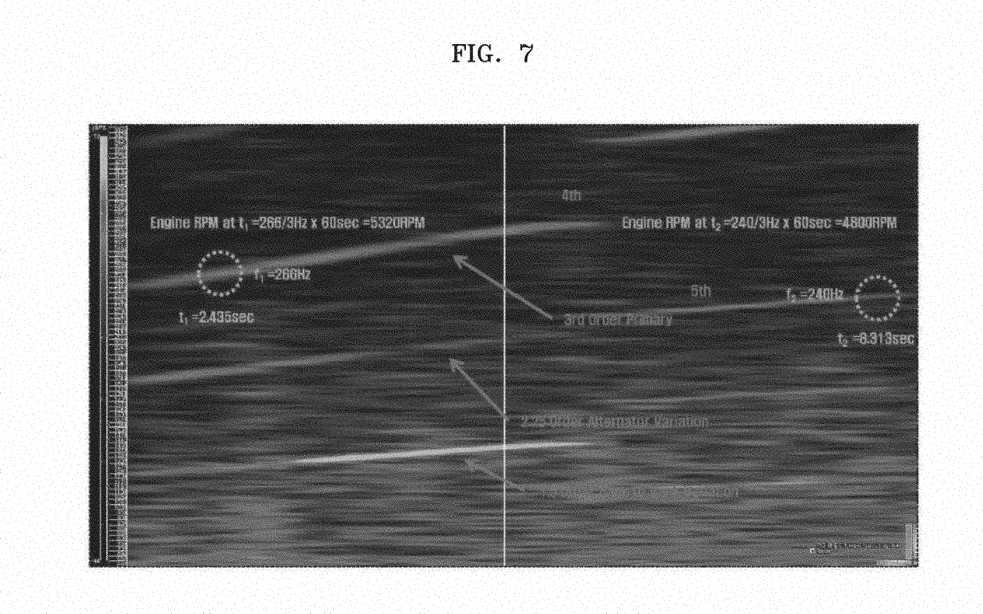

According to an embodiment, the acoustic analysis unit 330 may perform short-time Fourier transformation (STFT) on the time domain acoustic data to calculate a spectrogram including time-frequency-amplitude information. The spectrogram may be expressed in the form of a three-dimensional (3D) graph or a contour graph including the time-frequency-amplitude information, which will be described later with reference to FIG. 7 below.

Then, the acoustic analysis unit 330 estimates the RPM of the vehicle 1 at the event time from the frequency-domain acoustic data using order analysis to calculate RPM estimation data. When the RPM of the vehicle 1 is constant, sound generated by driving the main engine also has a constant period. Therefore, when frequency analysis is performed on the sound, a peak occurs in a specific frequency range and may be estimated by the RPM of the main engine.

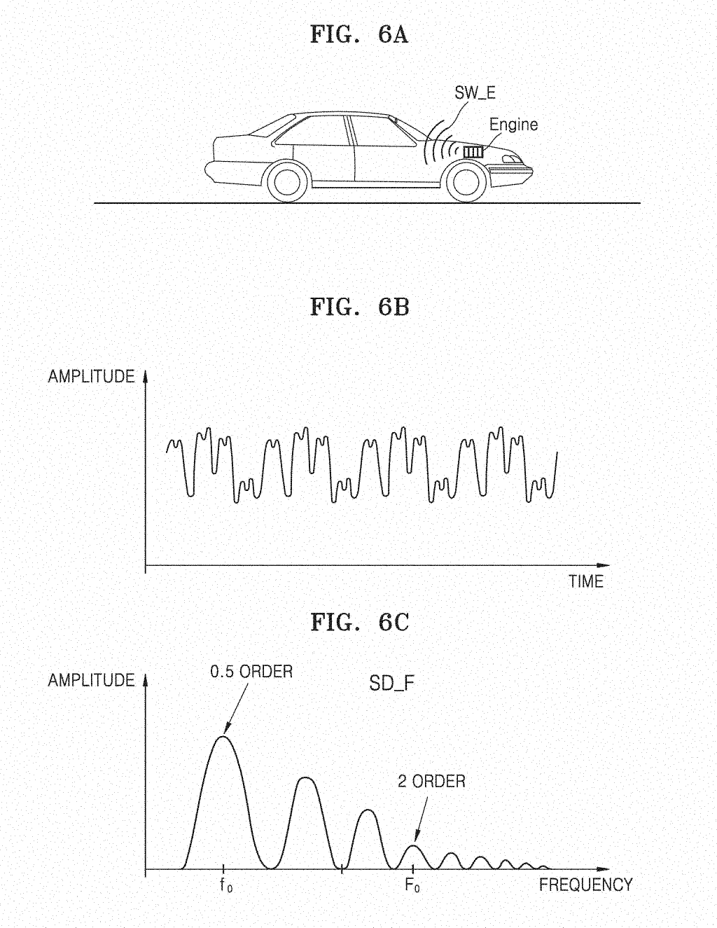

However, in general, the vehicle 1 includes not only an engine but also various mechanical systems, and thus frequencies of various orders are generated. Thus, order analysis may be performed to determine whether the peak is due to the RPM of the main engine. Specific methods of order analysis will be described later with reference to FIGS. 6 to 8.

The EDR recording time determination unit 340 compares the RPM estimation data calculated through the acoustic analysis of the acoustic analysis unit 330 with the RPM record data obtained from the EDR 100. The RPM estimation data is in a state before and after the ‘event time’. The RPM record data is in a state where a recording time is unknown due to a characteristic of the EDR 100 as described above.

According to an embodiment, when a difference between a value of the RPM record data at a reference time (0 second) and a value of the RPM estimation data at the event time is within a predetermined error range, the EDR recording time determination unit 340 may determine that a time when the RPM record data is recorded is identical to the event time. Alternatively, the EDR recording time determination unit 340 may compare a function within a predetermined time (for example, −5 to 0 seconds) from the reference time of the RPM record data and a function within the predetermined time (for example, −5 to 0 seconds) from the event time of the RPM estimation data and, when a difference between the two functions is within the predetermined error range, determine that the time when the RPM record data is recorded is identical to the event time. That is, in a state where origins of graphs of the two functions are identical to each other, in a case where a graph shape of the RPM record data and a graph shape of the RPM estimation data are identical to each other, the ‘recording time’ of the EDR 100 may be recognized as an actual ‘event time’.

According to an embodiment, the EDR recording time determination unit 340 compares the RPM estimation data with the first event record data and the second event record data to determine whether a time when the EDR 100 records the first event record data and the second event record data is identical to the event time. That is, in a case where two or more event records are stored in the EDR 100, the EDR recording time determination unit 340 may determine whether each event record occurs at an event time to be analyzed.

Hereinafter, a method of determining an EDR recording time using the EDR recording time determination apparatus 300 will be described.

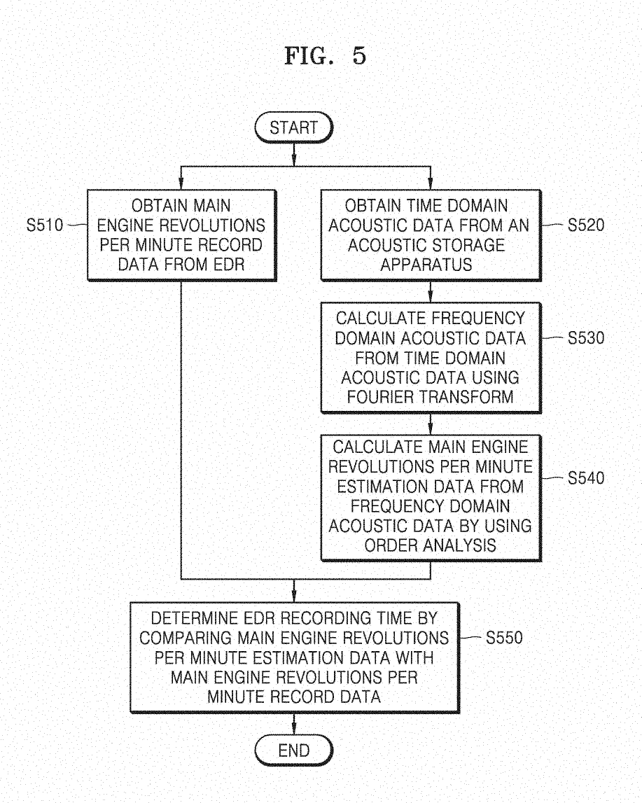

FIG. 5 is a flowchart illustrating an EDR recording time determination method according to an embodiment. Referring to FIG. 5, an operation (S510) of obtaining RPM record data of which recording time is unknown from the EDR 100 of the vehicle 1 and an operation (S520) of obtaining time domain acoustic data including acoustic information of an event time of the vehicle 1 from the acoustic storage apparatus 200 are performed. Since the two operations S510 and S520 may be performed in parallel, and thus any of the two operations may be performed first, or may be performed substantially simultaneously.

After the acoustic data obtaining operation (S520), an operation S530 of calculating frequency domain acoustic data using Fourier transform from the time domain acoustic data is performed.

FIG. 6 is a view schematically illustrating a principle of calculating frequency domain acoustic data using Fourier transformation, from time domain acoustic data.

Referring to (a) of FIG. 6, a main engine of the vehicle 1 periodically generates sound (hereinafter also referred to as “engine sound SW_E”) to vibration of a cylinder. Therefore, as shown in a time-amplitude graph of (b) of FIG. 6, time domain acoustic data SD_T including information generated in the vehicle 1 includes information of the engine sound SW_E that vibrates periodically. In addition to the engine sound SW_E, the time domain acoustic data SD_T has various sound information such as sound due to various mechanical systems connected to the engine and sound due to friction between tires and the road but in (b) of FIG. 6, for convenience of illustration, it is extremely simplified that the time domain acoustic data SD_T has only the information of the engine sound SW_E.

Thereafter, when Fourier transformation is performed on the time domain acoustic data SD_T, frequency-domain acoustic data SD_F may be calculated as shown in (c) of FIG. 6. At this time, Fast Fourier Transformation (FFT) may be used.

The time domain acoustic data SD_T includes the information of the engine sound SW_E that vibrates periodically as described above. At this time, when Fourier transform is performed on the time domain acoustic data SD_T, peaks appear at various points as shown in a graph of the frequency-domain acoustic data SD_F of (c) of FIG. 6. Among these, it is necessary to determine what peak corresponds to an engine fire rate of the entire engine, in order to calculate the RPM therefrom.

In the embodiments, the main engine revolutions per minute (RPM) is calculated from frequency domain acoustic data by using order analysis. A primary order of the main engine of the vehicle 1 may be determined using the number of engine cylinders in information of the vehicle 1 and the RPM may be calculated from frequency data corresponding to the primary order. In general, since the vehicle 1 is composed of various engine systems as well as an engine, various orders of frequency may be generated. At this time, a frequency f0 of sound generated from one engine cylinder may correspond to a 0.5 order. In this case, when the engine includes multiple cylinders, since each cylinder must be driven once, one engine cycle will occur, and thus the ‘primary order’ regarding the frequency of the entire main engine depends on the number of cylinders. For example, in the case of the vehicle 1 including a four-stroke four-cylinder engine, a second order which is four times the 0.5 order may be the primary order, and in the case of the vehicle 1 including six cylinders, a third order may be the primary order. In (c) of FIG. 6, it is illustrated that the second order is the primary order. The primary order may determined using the information of the vehicle 1, and the RPM may be calculated from the frequency data F₀ corresponding to the primary order through Equation 1 below,

RPM=F₀/p×60×2 [Equation 1]

wherein F₀ denotes a frequency corresponding to the primary order, and p denotes the number of cylinders of the engine.

On the other hand, in the frequency-amplitude graph obtained by performing Fourier transform on the time domain acoustic data SD_T through a general method as shown in (c) of FIG. 6, a change in the RPM over time may not be determined. Therefore, in order to estimate a temporal change of the RPM, it is preferable to utilize data simultaneously indicating frequency information and time information.

According to an embodiment, an operation of obtaining the frequency domain acoustic data SD_F includes an operation of performing STFT on the time domain acoustic data SD_T to generate a spectrogram including the time-frequency-amplitude information. STFT is a method of performing Fourier transform on a signal in a time domain over time through a window having a predetermined interval, and the spectrogram may be obtained by summing Fourier transformed spectra for each time. The spectrogram includes the time-frequency-amplitude information and may be expressed in the form of a three-dimensional (3D) graph or a contour graph.

FIG. 7 is an analysis example of a spectrogram obtained by performing STFT on time domain acoustic data obtained from a black box. Since the spectrogram is obtained through STFT in FIG. 7, frequency data for obtaining RPM estimation data may be expressed as a function of time. At this time, since the event vehicle 1 had a six-cylinder engine, a primary order was a third order. Therefore, in the above analysis example, the RPM estimation data may be calculated from frequency data corresponding to the third order according to Equation 1.

Referring again to FIG. 5, after the RPM estimation data calculation operation S530, an EDR recording time determination operation (S540) of comparing the RPM estimation data with the RPM record data to determine whether the time when the EDR 100 records the RPM record data is identical to the event time is performed.

In the EDR recording time determination operation S540, a value of the RPM record data at the reference time point (0 second) and the value of the RPM estimation data at the event time may be compared. For example, when a tolerance range is 10%, in a case where the RPM of the RPM record data of the EDR 100 at the reference time (0 second) is 5000, and the RPM of the RPM estimation data at the event time obtained through acoustic analysis is within a range of 5000±500, since two values are the same, it may be determined that a record of the EDR 100 is due to an ‘event to be actually analyzed’. Conversely, in a case where the RPM of the RPM estimation data at the event time obtained from the acoustic analysis is out of the range of 5000±100, since the two values are different, it may be determined that the record of the EDR 100 is not due to the ‘event to be actually analyzed’. It should be understood that the above-described tolerance range is merely exemplary and does not limit the embodiments.

Further, in the EDR recording time determination operation S540, a function within a predetermined time (for example, −5 to 0 seconds) from the reference time of the RPM record data and a function within the predetermined time (for example, −5 to 0 seconds) from the event time of the RPM estimation data may be compared. At this time, in a state where origins of graphs of the two functions are identical to each other, in a case where a graph shape of the RPM record data and a graph shape of the RPM estimation data are identical to each other, since the two graphs are the same, it may be determined that the record of the EDR 100 is due to the ‘event to be actually analyzed’. In this case, the user may conclude that the record of the EDR 100 may be utilized for event analysis.

Hereinafter, an analysis example in which the RPM estimation data and the RPM record data are compared to determine an EDR recording time will be described.

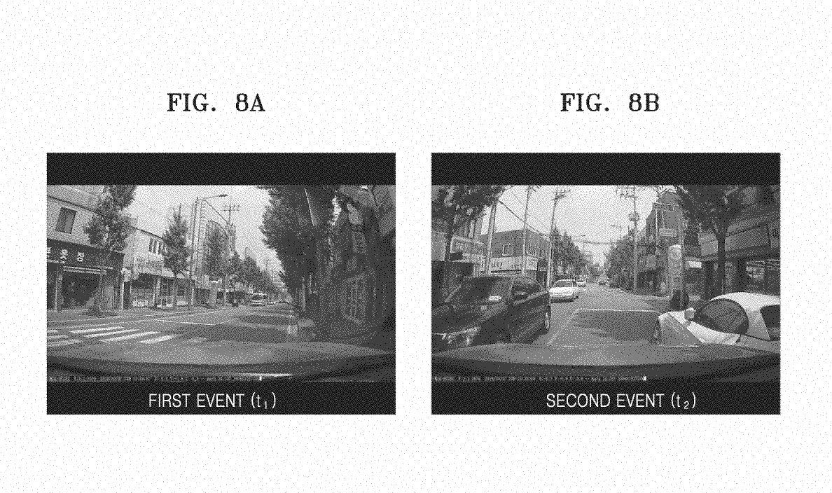

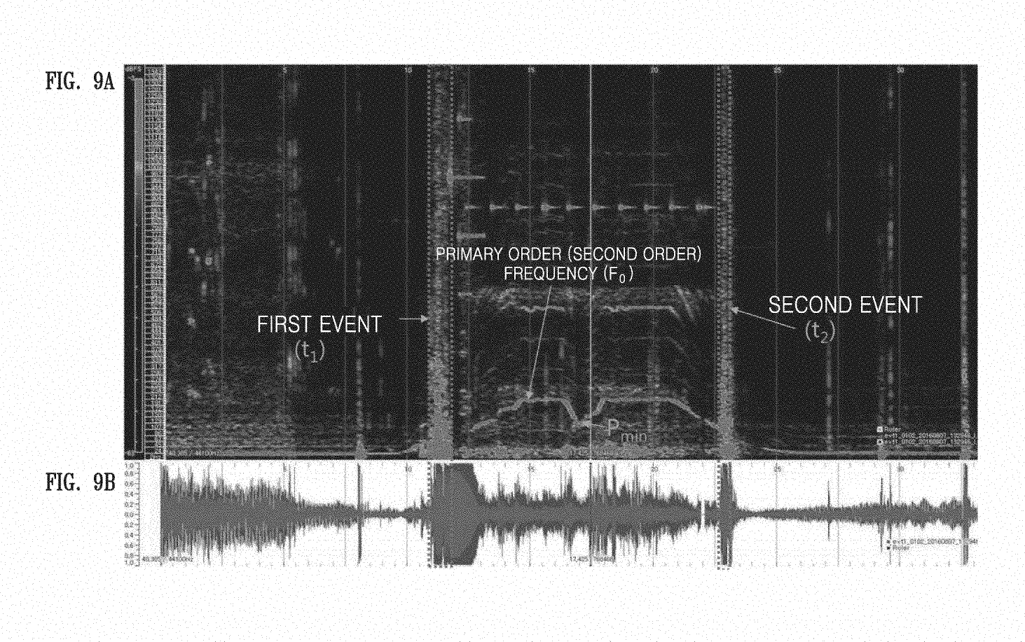

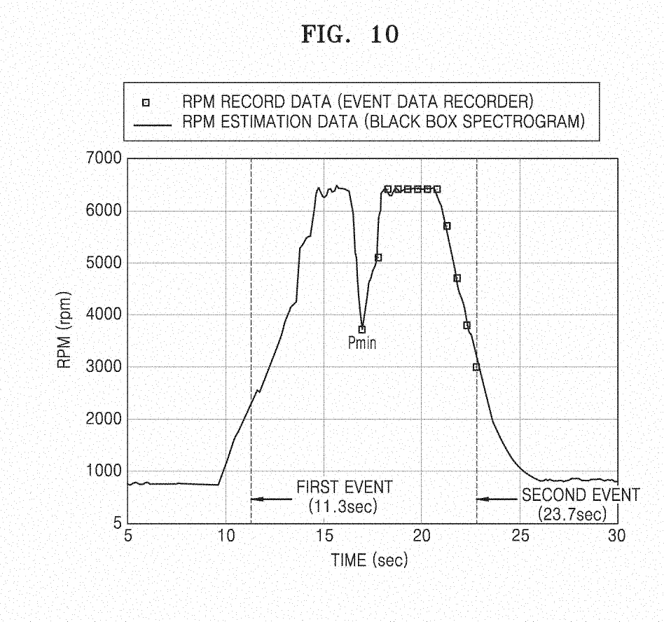

FIG. 8 is a partial view of a black box image of the vehicle 1 with respect to which two events occurred. FIG. 9 is a spectrogram and a time domain acoustic data graph before and after the events, calculated from black box acoustic information. FIG. 10 is a graph comparing RPM record data and RPM measurement data of the events.

Referring to FIG. 8, in an analysis example, an impact occurs in the vehicle 1 at a first time (t₁=11.3 sec) (a first event) due to an unknown cause. Thereafter, the vehicle 1 travels for about 12 seconds, and then collides with the preceding vehicle 1 at a second time (t₂=23.7 sec) (a second event).

(a) of FIG. 9 shows the spectrogram obtained by analyzing the acoustic data obtained from a black box of the vehicle 1. In the present analysis example, the vehicle 1 has a four-cylinder engine, and a primary order is a second order, which may derive a frequency F₀ corresponding to the second order in the spectrogram. Referring to (b) of FIG. 9, amplitude of the time domain acoustic data graph suddenly increases at the time of the first event and the second event, which may determine the first event time t₁ and the second event time t₂.

Upon reviewing the graph of the primary order frequency F₀ between the first event and the second event, a RPM increases and then remains relatively constant after the first event. Thereafter, the RPM decreases once around a minimum point Pₘᵢₙ, then increases again and then remains constant, and then decreases immediately before the second event.

Referring to FIG. 10, the graph of the RPM measurement data obtained from the primary order frequency obtained from FIG. 9 through Equation 1 is shown in a solid line.

In the present analysis example, only one event record is stored in the EDR 100. At this time, data stored in the EDR 100 is shown in Table 1 below.

TABLE 1

| Time (sec) | RPM | Speed (km/h) | Brake | Accelerator Pedal Position |
|---|---|---|---|---|
| −5 | 5100 | 34 | OFF | 100 |
| −4.5 | 6400 | 34 | OFF | 100 |
| −4 | 6400 | 35 | OFF | 100 |
| −3.5 | 6400 | 33 | OFF | 100 |
| −3 | 6400 | 30 | OFF | 100 |
| −2.5 | 6400 | 27 | OFF | 100 |
| −2 | 6400 | 24 | OFF | 0 |
| −1.5 | 5700 | 21 | OFF | 0 |
| −1 | 4700 | 17 | OFF | 0 |
| −0.5 | 3800 | 14 | OFF | 0 |
| 0 | 3000 | 10 | OFF | 0 |

Thereafter, it may be seen that the RPM record data graph is drawn by corresponding a ‘0 second’ of the EDR 100 to the second event time t₂ in the RPM measurement data graph as shown in a square of FIG. 10. At this time, since the RPM measurement data graph and the RPM record data graph are identical, it may be seen that an event recording time of the EDR 100 is the ‘second event time t₂’. Therefore, when analyzing the cause of the secondary event, it may be seen that the event record of the EDR 100 may be utilized.

The above analysis example is a case in which one event record is stored in the EDR 100, but the method of the embodiments may be applied even when a plurality of event records are stored in the EDR 100.

According to an embodiment, the RPM record data may include first event record data DR1 and second event record data DR2. The EDR recording time determination operation S550 may include an operation of comparing EDR estimation data with the first event record data DR1 and the second event record data DR2 and determining whether a time when the EDR 100 records the first event record data DR1 and the second event record data DR2 are identical to an event time tₐ. At this time, before the determination operation S550, generation time and order of the first event record data DR1 and the second event record data DR2 are in an unknown state.

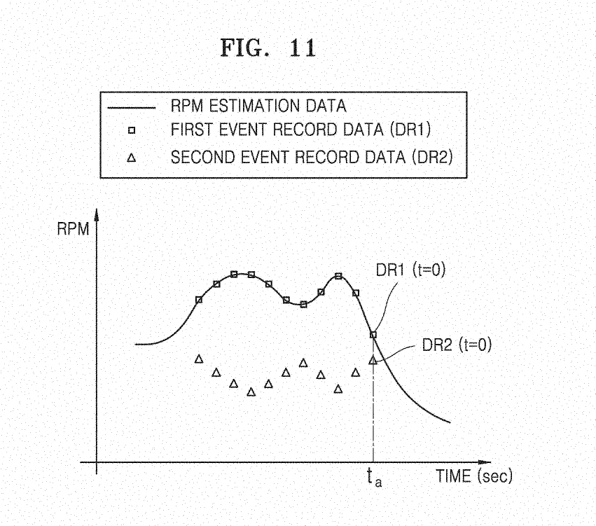

FIG. 11 is a graph for explaining a case in which one of a plurality of event record data corresponds to EDR measurement data. If, for example, two event recording data are included in the EDR 100, a ‘0 second’ of each data may correspond to the event time tₐ in a RPM measurement data graph. In this case, when a RPM record data graph of any one event record data is identical to the RPM measurement data graph, it may be seen that a recording time of the identical data is the event time tₐ.

For example, in FIG. 11, a RPM recording data graph of the ‘second event record data DR2’ is identical to the RPM measurement data graph, but a RPM recording data graph of the ‘first event record data DR1’ is not identical to the RPM measurement data graph. In this case, it may be confirmed that a data recording time of the ‘second event record data DR2’ is the event time tₐ.

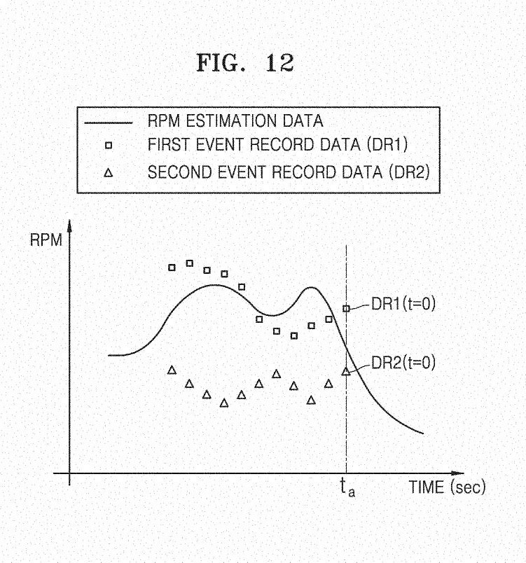

FIG. 12 is a graph for explaining a case in which all of a plurality of event record data are not identical to EDR measurement data. In a case where the EDR 100 includes, for example, the two event record data DR1 and DR2, a ‘0 second’ of each of the data DR1 and DR2 may correspond to the event time tₐ of a RPM measurement data graph. In this case, when any of the event record data DR1 and DR2 is not identical to the RPM measurement data, it may be seen that not all of records recorded in the EDR 100 are recorded at the event time tₐ to be analyzed. In this case, a user may conclude that record information of the EDR 100 may not be utilized.

Although a method of determining an EDR recording time through RPM information of the vehicle 1 is described above, the EDR recording time may be determined through speed information of the vehicle 1. At this time, the EDR 100 stores speed record data of which recording time is unknown. The EDR recording time determination apparatus 300 acoustically analyzes data obtained from the acoustic storage apparatus 100 to estimate the speed of the vehicle 1.

When estimating the speed of the vehicle 1 through acoustic analysis, the speed of the vehicle 1 may be calculated using information such as a RPM and a gear ratio of the vehicle 1, a final reduction ratio of a differential gear, a radius of a tire, etc. according to Equation 2 below.

$$Vehicle speed = \frac{main engine revolutions per minute}{\begin{matrix}gear ratio of each state \times \\ final reduction ratio\end{matrix}} \times π \times R \times 60 \qquad [ Equation 2 ]$$

wherein R denotes a diameter (mm) of the tire mounted on the vehicle 1, and may be calculated as shown in Equation 3 below.

$$R = ( \frac{Tire width \times flatness ratio}{100} ) \times 2 + ( wheel inch \times 25.4 ) \qquad [ Equation 3 ]$$

The gear ratio of each stage, the final reduction ratio, and the tire size of the vehicle 1 may be previously known values, and may be searched from the outside as required. At this time, the number of stages of the vehicle 1 may be estimated by using frequency data in a section where the vehicle 1 is shifting. However, it is difficult to estimate the number of stages by only frequency data in a certain section in which the speed of the vehicle 1 is not shifted. Therefore, the number of stages of the vehicle 1 corresponding to a specific image time may be estimated an average speed at the specific image time calculated using the specific image time and a driving distance corresponding to the specific image time from a black box. The gear ratio in Equation 2 may be a gear ratio corresponding to the estimated number of stages of the vehicle 1.

Thereafter, the EDR recording time determination apparatus 300 may determine whether the speed record data and speed estimation data are identical to each other to determine the EDR recording time.

According to the EDR recording time determination apparatus 300 and the method according to an embodiment, it is possible to determine whether a recording time of the EDR 100 of the vehicle 1 is identical to an event time to be analyzed. Accordingly, it is possible to confirm whether an event record stored in the EDR 100 is caused by an event to be actually analyzed. The embodiments as described above may be particularly useful when a result of analyzing an event cause is confirmed using the EDR 100.

Meanwhile, the EDR recording time determination method according to an embodiment may be implemented as a program that may be executed in a computer and may be implemented in a general-purpose digital computer that operates the program using a computer-readable recording medium. The computer-readable recording medium includes a storage medium such as a magnetic storage medium (e.g., ROM, floppy disk, hard disk, etc.) and an optical reading medium (e.g., CD ROM, DVD, etc.).

As described above, according to the apparatus and method for determining a recording time of an EDR according to an embodiment, it is possible to determine whether the recording time of the EDR of a vehicle is identical to an event time to be analyzed, which makes it possible to ensure that an event record stored in the EDR is caused by an event to be actually analyzed. The embodiments as described above may be particularly useful when a result of analyzing an event cause is confirmed using the EDR.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A method of determining a recording time of an event data recorder (EDR), the method comprising:
obtaining, from the EDR of a vehicle, main engine revolutions per minute (RPM) record data of which the recording time is unknown;
obtaining, from an acoustic storage apparatus, time domain acoustic data comprising acoustic information of an event time of the vehicle;
calculating frequency domain acoustic data from the time domain acoustic data by using Fourier transformation;
calculating RPM estimation data of the vehicle of the event time from the frequency domain acoustic data by using order analysis; and
determining whether a time when the EDR records the RPM record data is identical to the event time by comparing the RPM estimation data of the vehicle with the RPM record data.

2. The method of claim 1, wherein the determining comprises: in a case where a difference between a value of the RPM record data at a reference time and the a value of the RPM estimation data at the event time is within a predetermined error range, determining that the time when the EDR records the RPM record data is identical to the event time.

3. The method of claim 1, wherein the RPM record data comprises first event record data and second event record data, and
wherein the determining comprises: determining whether a time when the EDR records the first event record data and the second event record data is identical to the event time by comparing the RPM estimation data with each of the first event record data and the second event record data.

4. An apparatus for determining a recording time of an event data recorder (EDR), the apparatus comprising:
an EDR data obtaining unit configured to obtain, from the EDR of a vehicle, main engine revolutions per minute (RPM) record data of which the recording time is unknown;
time domain acoustic data obtaining unit configured to obtain, from an acoustic storage apparatus, time domain acoustic data comprising acoustic information of an event time of the vehicle;
an acoustic analysis unit configured to calculate frequency domain acoustic data from the time domain acoustic data by using Fourier transformation and calculate RPM estimation data of the vehicle of the event time from the frequency domain acoustic data by using order analysis; and
an EDR recording time determination unit configured to determine whether a time when the EDR records the RPM record data is identical to the event time by comparing the RPM estimation data of the vehicle with the RPM record data.

5. The apparatus of claim 4, wherein, in a case where a difference between a value of the RPM record data at a reference time and the a value of the RPM estimation data at the event time is within a predetermined error range, the EDR recording time determination unit is further configured to determine that the time when the EDR records the RPM record data is identical to the event time.

6. The apparatus of claim 4, wherein the RPM record data comprises first event record data and second event record data, and
wherein the EDR recording time determination unit is further configured to determine whether a time when the EDR records the first event record data and the second event record data is identical to the event time by comparing the RPM estimation data with each of the first event record data and the second event record data.

7. A non-transitory computer-readable recording medium having recorded thereon a program for performing the method of any one of claims 1 to 3 in a computer.
